(19) United States
(12) Patent Application Publication
(10) Pub. No.: US 2026/0259755 A1
(43) Pub. Date: Sep. 3, 2026

(54) METHOD, APPARATUS, DEVICE AND STORAGE MEDIUM FOR INTERFACE INTERACTION

(71) Applicant: Beijing Zitiao Network Technology Co., Ltd., Beijing (CN)

(72) Inventor: Jiayi Xu, Beijing (CN)

(21) Appl. No.: 19/555,634

(22) Filed: Mar. 3, 2026

(30) Foreign Application Priority Data
Mar. 3, 2025 (WO) PCT/CN2025/080246

(51) Int. Cl. G06F 9/451; G06F 3/04845

(52) U.S. Cl. CPC G06F 9/453; G06F 3/04845

(57) ABSTRACT

Embodiment of the disclosure provides methods, apparatuses, devices, storage media and program products for interface interaction. An example method includes: displaying a viewing interface of a media content; displaying a guidance element in the viewing interface, the guidance element comprising description information associated with a target interaction content of the media content; and displaying the target interaction content of the media content in response to a predetermined operation for the guidance element. Based on this manner, the embodiments of the disclosure may quickly perform interface positioning by viewing the guidance element of the interface, thereby helping the user better obtain the information of the target interaction content.

### CROSS-REFERENCE

This application claims priority to International Application No. PCT/CN2025/080246, filed on Mar. 03, 2025, and entitled ‘METHOD, APPARATUS, DEVICE AND STORAGE MEDIUM FOR INTERFACE INTERACTION’, which is incorporated herein by reference in its entirety.

### FIELD

Example embodiments of the present disclosure generally relate to the field of computers, and in particular, to a method, apparatus, device, and computer-readable storage medium for interface interaction.

### BACKGROUND

With the development of computer levels, electronic devices in various forms may greatly enrich people's daily life. For example, people may use electronic devices to learn a variety of media content, and the interaction design of the terminal interface becomes an important factor affecting the efficiency of content obtaining.

### SUMMARY

In a first aspect of the present disclosure, a method for interface interaction is provided. The method includes: displaying a viewing interface of a media content; displaying a guidance element in the viewing interface, the guidance element including description information associated with a target interaction content of the media content; and displaying the target interaction content of the media content in response to a predetermined operation for the guidance element.

In a second aspect of the present disclosure, an apparatus for interface positioning is provided. The apparatus includes: a first display module configured to display a viewing interface of a media content; a second display module configured to display a guidance element in the viewing interface, the guidance element including description information associated with a target interaction content of the media content; and a third display module configured to display the target interaction content of the media content in response to a predetermined operation for the guidance element.

In a third aspect of the present disclosure, an electronic device is provided. The device includes: at least one processor; and at least one memory coupled to the at least one processor and storing instructions for execution by the at least one processor, the instructions, when executed by the at least one processor, causing the electronic device to perform the method of the first aspect.

In a fourth aspect of the present disclosure, a computer-readable storage medium is provided. The computer-readable storage medium has a computer program stored thereon, the computer program, when executed by a processor, implementing the method of the first aspect.

In a fifth aspect of the present disclosure, a computer program product is provided. The computer program product includes computer-executable instructions, where the computer-executable instructions, when executed by a processor, implement the method of the first aspect of the present disclosure.

It would be appreciated that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, where:

FIG. 1 illustrates a schematic diagram of an example environment in which embodiments of the present disclosure may be implemented;

FIG. 2 is a flowchart of an interface interaction process according to some embodiments of the present disclosure;

FIG. 3 illustrates a first schematic diagram of a viewing interface according to some embodiments of the present disclosure;

FIG. 4 is a schematic diagram of a guidance element according to some embodiments of the present disclosure;

FIG. 5 illustrates a second schematic diagram of a viewing interface according to some embodiments of the present disclosure;

FIG. 6 illustrates a schematic structural block diagram of an apparatus for interface interaction according to some embodiments of the present disclosure;

FIG. 7 illustrates a block diagram of an electronic device capable of implementing various embodiments of the present disclosure.

### DETAILED DESCRIPTION

Embodiments of the present disclosure would be described in more detail below with reference to the accompanying drawings. While certain embodiments of the present disclosure are illustrated in the accompanying drawings, it would be appreciated that the present disclosure may be implemented in various forms and would not be construed as limited to the embodiments set forth herein. Rather, these embodiments are provided for a more thorough and complete understanding of the present disclosure. It would be appreciated that the drawings and embodiments of the present disclosure are for example purposes only and are not intended to limit the scope of the present disclosure.

It would be appreciated that the title of any section/subsection provided herein is not limiting. Various embodiments are described throughout, and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms ‘including’ and the like would be understood to include ‘including but not limited to’. The term ‘based on’ would be understood as ‘based at least in part on’. The terms ‘one embodiment’ or ‘the embodiment’ would be understood as ‘at least one embodiment’. The term ‘some embodiments’ would be understood as ‘at least some embodiments’. Other explicit and implicit definitions may also be included below. The terms ‘first,’ ‘second,’ and the like may refer to different or identical objects. Other explicit and implicit definitions may also be included below.

Embodiments of the present disclosure may relate to data of a user, obtaining and/or use of data, and the like. These aspects all follow the corresponding laws and regulations and related regulations. In the embodiments of the present disclosure, all data collection, acquisition, processing, handling, processing, reposting, use, and the like are carried out on the premise of the knowledge and confirmation of the user. Accordingly, when implementing the embodiments of the present disclosure, the types of the data or information that may be involved, the usage scope, the usage scenario, and the like would be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, processing may be performed on the premise of having a legality basis (for example, obtaining consent of a personal information subject, or necessary for performing a fulfillment contract), and processing only within a specified or agreed range. The user rejects personal information other than necessary information required by the basic function and may not affect the basic function of the user.

Conventionally, a user may browse content displayed in a terminal interface sliding the interface up and down, but if the content displayed in the terminal interface is too large, the user needs to spend a significant time cost to browse the content and cannot quickly browse important content.

Embodiments of the present disclosure provide an interface interaction solution. According to the scheme, a viewing interface of media content is displayed; a guidance element is displayed in the viewing interface, the guidance element including description information associated with a target interaction content of the media content; and the target interaction content of the media content is displayed in response to a predetermined operation for the guidance element. Since the guidance element is set in the viewing interface, the embodiments of the present disclosure may quickly locate the interaction content related to the media content through the guidance element of the viewing interface, thereby helping the user to better obtain the information of the target interaction content.

### Example Environment

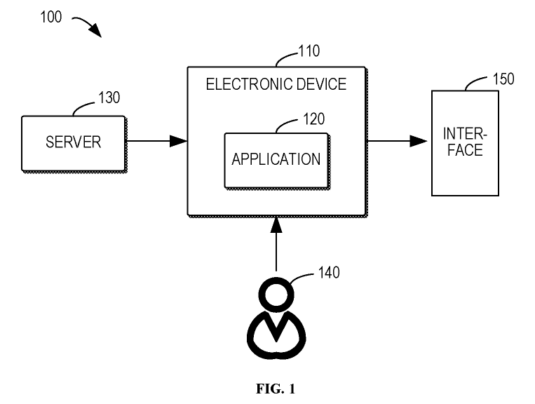

FIG. 1 illustrates a schematic diagram of an example environment 100 in which embodiments of the present disclosure may be implemented. As illustrated in FIG. 1, the example environment 100 may include an electronic device 110.

In the example environment 100, the electronic device 110 may run an the application 120 that supports interface interaction. The application 120 may be any suitable type of application for interface interaction, examples of which may include, but are not limited to: a video application, a social application, or other suitable application.

In the environment 100 of FIG. 1, if the application 120 is active, the application 120 may provide a display interface 150 for the user 140.

It would be appreciated that, in addition to the interface displayed based on the application 120, the interface 150 may be any suitable interface (not shown in the figure), and details are not described herein again.

The electronic device 110 may display the viewing interface 150 of the media content and display a guidance element in the viewing interface 150, and then the electronic device 110 may update the viewing interface 150 in response to a predetermined operation for the guidance element to display a target interaction content of the media content.

In some embodiments, the electronic device 110 may correspond to any suitable operating system.

In some embodiments, the electronic device 110 communicates with the server 130 to enable provisioning of services to the application 120. The electronic device 110 may be any type of mobile terminal, fixed terminal, or portable terminal with a display device, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a target user (such as a “wearable” circuit, etc.).

The server 130 may be a standalone physical server, or may be a server cluster or a distributed system composed of a plurality of physical servers, or may be a cloud server that provides basic cloud computing services such as cloud services, cloud databases, cloud computing, cloud computing, cloud functions, cloud storage, network services, cloud communications, middleware services, domain name services, security services, content distribution networks, big data and artificial intelligence platforms. The server 130 may include, for example, a computing system/server, such as a mainframe, an edge computing node, a computing device in a cloud environment, or the like. The server 130 may provide background services for applications 130 that support interface interaction in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (Wi-Fi) connection, and the like, and the embodiments of the present disclosure are not limited in this aspect. In an embodiment of the present disclosure, the server 130 and the electronic device 110 may implement signaling interaction through a communication connection therebetween.

It would be appreciated that the structures and functions of the various elements in the environment 100 are described for example purposes only and do not imply any limitation to the scope of the present disclosure.

Some example embodiments of the present disclosure will be described below with continued reference to the accompanying drawings.

### Example Processes

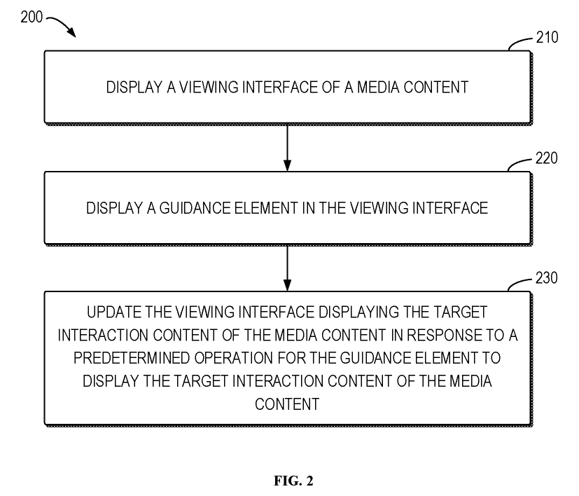

FIG. 2 illustrates a flowchart of a process 200 of interface positioning according to some embodiments of the present disclosure. The process 200 may be implemented at the electronic device 110. The process 200 is described below with reference to FIG. 1.

At block 210, the electronic device 110 displays a viewing interface for a media content.

In some examples, the media content refers to information, entertainment, educational or advertising materials disseminated through various media, which can be in various forms, such as text form, audio form, image form, video form, etc. in one or several forms, which will not be repeated here.

In some examples, the viewing interface refers to an interface for browsing, viewing, or accessing information when a user interacts with a system, an application program, or a device, and is an important way for a user to obtain data, content or system states.

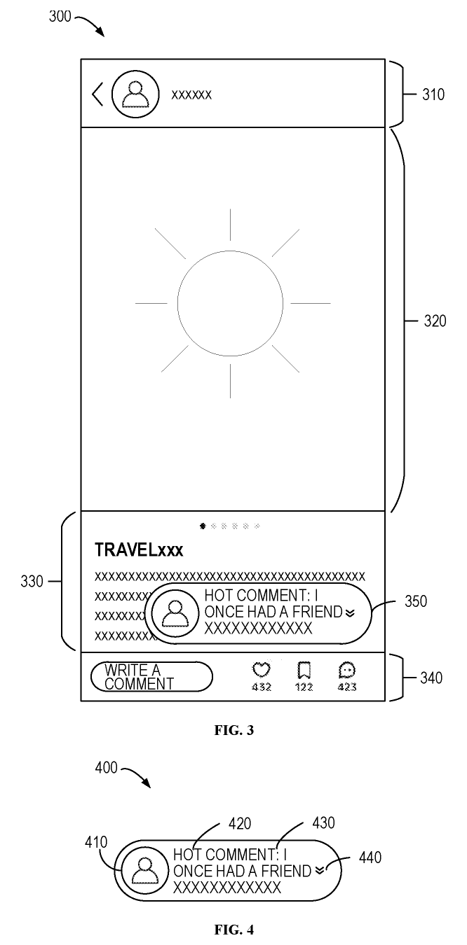

In some examples, the media content may include, for example, a media work posted by the user, for example, a graphic work, a video work, and the like. Accordingly, the viewing interface may, for example, be a viewing interface for the graphic work or the video work. For example, the electronic device 110 may display a viewing interface 300, as shown in FIG. 3, through which the user may understand the media content displayed thereon.

At block 220, the electronic device 110 displays a guidance element in the viewing interface.

In some scenarios, the guidance element may be included in a web page, application program, or other interface for guiding a user to perform a particular operation, browsing, or understanding elements of the content. As an example, the presentation form of the guidance element may be a button, an icon, prompt information, or the like, which is not repeated herein.

In some embodiments, the interface may not be able to be completely displayed in the terminal interface because the terminal interface has a size limitation, then for the interface that cannot be completely displayed in the terminal interface, other contents of the interface may be displayed in the terminal interface by means of interface positioning or the like.

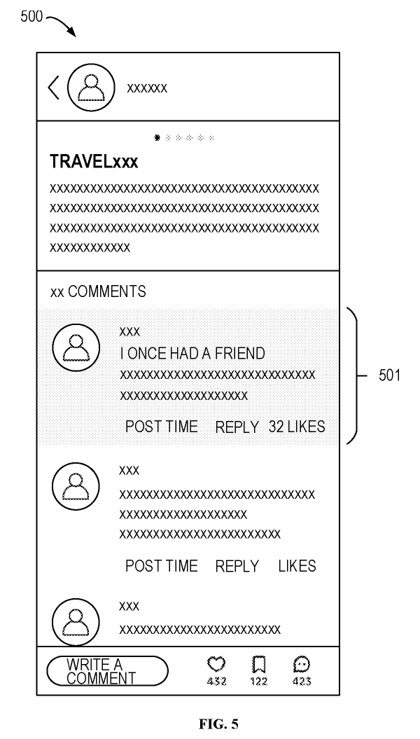

In some examples, interface positioning refers to determining a specific location and layout of interface elements on a screen or in an interface to implement efficient user interaction and good visual effects, so that the user can quickly find the required information and functions, and improve ease of use and user experience. For example, FIG. 3 illustrates a first type of viewing interface 300, FIG. 3 is switched to FIG. 5 after an interface positioning operation, and FIG. 5 illustrates a second type of viewing interface 500, so that the user can quickly locate from FIGS. 3 to FIG. 5 and browse the target interactive content on FIG. 5 by the method of interface interaction.

In some embodiments, the guidance element includes description information associated with a target interaction content of the media content, which may help the user implement the function of interface positioning, that is, the user may perform an interface positioning operation based on the guidance element in the viewing interface.

In some embodiments, the media content may be an article, a video, a motion, etc. uploaded by a media content sharing party, and the media content may include one or more of the forms of images, audio, video, text, etc., which are not described herein. The interaction content is the content corresponding to the media content, and the interaction content may be the concerns, comments made, and favorites attached to the media content by other users, and the like. For example, the electronic device 110 may set the interaction content as a comment on the media content.

Since too much interaction content may impose a considerable browsing cost on the user's browsing, thereby reducing the user's experience, if the target interaction content with the highest level of importance may be quickly filtered from a large amount of interaction content, it may enable the user to quickly learn the most important information about the interaction content. In some embodiments, the target interaction content may be determined to be the content with the highest level of heat in the interaction content, i.e., the comment content generated for the media content that receives a lot of attention and discussion and has a high number of likes, replies, or retweets, which is of high interest and strong interaction.

In some embodiments, the electronic device 110 may display a guidance element 350 in the form of bubbles in the viewing interface 300 as shown in FIG. 3. The viewing interface in FIG. 3 includes media content, the media content includes an image content area 320 and a text content area 330 “travel xxx”, the guidance element 350 is related to a target interaction content “I once had a friend”, and the user can position the viewing interface to the location of the target interaction content by triggering the guidance element 350.

In some embodiments, the electronic device 110 may further display a user information area 310 in the viewing interface 300 shown in FIG. 3, where the user information area 310 is used to display information associated with the media content poster. For example, the user information area 310 may display information such as a name and an avatar of the media content poster, and details are not described herein again. In addition, the electronic device 110 may further display an interaction control 340 in the viewing interface 300 as shown in FIG. 3, and the interaction control 340 may implement interaction between the user and the interface. For example, the user may comment on the media content through the “write a comment” block in the interaction control 340, and may also implement functions such as liking, collection, and viewing the media content by using the icon on the right side of the interaction control 340, which is not described herein again.

In some embodiments, the guidance element displayed by the electronic device 110 may include at least part of the target interaction content, for example, FIG. 4 illustrates a display method of the guidance element, and the guidance element includes all or part information 430 of the target interaction content.

In some embodiments, since the guidance element has a size limitation, the target interaction content may not be completely displayed in the guidance element. The guidance element only displays all or part of the target interaction content based on the corresponding size limitation. Accordingly, the electronic device 110 may associate the guidance element with a maximum display size, where the at least part of the content is determined based on the maximum display size. That is, if the content of the target interaction content is very long, the target interaction content is truncated at a location beyond the control size limit, and only the first half of the truncated part of the target interaction is displayed in the guidance element; and if the content of the target interaction content is very short and does not exceed the size limit of the guidance element, the target interaction content is completely displayed on the guidance element. Such guidance element may enable the user to directly understand all or part of the target interaction content based on the guidance element, so that the user can decide whether or not the user is interested in the target interaction content.

For example, if the complete target interaction content is “I once had a friend, we travel together”, and the guidance element may only display eight characters due to the limitation of size, then the complete target interaction content “I once had a friend, we travel together” may be truncated, and only “I once had a friend” is displayed on the guidance element. For a further example, if the complete target interaction content is “I once had a friend”, since the target interaction content only includes eight characters, the target interaction content may be completely displayed on the guidance element.

In some embodiments, the guidance element displayed by the electronic device 110 may further include identification information of a poster of the target interaction content, for example, FIG. 4 illustrates a display method of the guidance element, and the guidance element includes poster identification information 410, where the poster identification information 410 is information that may be used to indicate a poster identity of the target interaction content. For example, the poster identification information 410 may be identity information such as poster avatar information corresponding to the poster of the target interaction content. Such guidance element may enable the user to understand who the poster of the target interaction content is interested directly based on the guidance element, so that the user decides whether to be interested in the target interaction content.

In some embodiments, the target interaction content may also include, for example, media content of a type such as a picture. Accordingly, the guidance element may include, for example, at least part of the picture to facilitate the user to conveniently perceive the content of a hot comment picture.

In some embodiments, the guidance element may further include only identification information of the poster of the target interaction content, or only include at least part of the target interaction content, which is not limited in this embodiment of the present disclosure.

In some embodiments, the guidance element displayed by the electronic device 110 may further include interaction information associated with the target interaction content, for example, the guidance element may further include an icon 440 indicating that the guidance element has a function of positioning the interface to the location of the target interaction content. For a further example, the guidance element may further include a predetermined context “hot comment” 420 indicating a function of the guidance element and an importance degree of the target interaction content displayed in the guidance element. For example, if the user sees a predetermined context “hot comment” on the guidance element, the user can understand that the guidance element can locate the interface to the location of the hot comment, which greatly reduces the cost of understanding the new page element. The predetermined copywriting may be correspondingly adjusted according to actual needs, and details are not described herein again.

In some embodiments, the guidance element may be displayed over the media content such that at least a part of the media content is not visible. For example, FIG. 3 illustrates a display method of the viewing interface, the guidance element 350 is displayed on the media content in an opaque manner, and the media content “travel xxx” is partially occluded.

In some embodiments, since the guidance element partially occludes the media content, in order to ensure that the user understands as much of the media content as possible when the media content is occluded, the guidance element 350 may be set at a location at the lower part of the viewing interface 300 as shown in FIG. 3, e.g., the guidance element 350 may be set at a location directly underneath, to the lower right of, or to the lower left of the viewing interface 300, etc., so that the first line or the first few lines of the text in the media content are not occluded, so that the user can understand the subject matter and other information of the media content as soon as possible through the exposed part of the media content. In addition, since the browsing order of the text in the media content is from left to right, the guidance element 350 may be provided at the bottom right of the viewing interface 300 so that the user can also see the first half of the occluded lines in the media content, thereby minimizing the browsing impact of the occlusion for the user.

In some embodiments, since the media content may also include images, audio and video content, etc., the user is more capable of quickly understanding information from the images or audio and video content than from the text, the viewing interface may include a media display area as shown in FIG. 3, which includes the image content area 320, and the text content area 330, where the image content area 320 and the text content area 330 are used to display the media display area. The image content area 320 may be used to display an image content or an audio/video content in the media content, and the text content area 330 may be used to display a text content in the media content. The electronic device 110 may set the guidance element 350 underneath the image content area 320 in order to avoid the guidance element to the image content area 320 to be occlude the image content area 320.

In some embodiments, the electronic device 110 may also set a transparency of the guidance element in the viewing interface to ensure that the user can simultaneously understand the content included in the guidance element, and the media content that is occluded, which transparency may be set based on the actual situation, and will not be discussed herein.

In some embodiments, the electronic device 110 may display, in the viewing interface, an interaction control for receiving an interaction content associated with the media content, and displaying the guidance element in the viewing interface includes: displaying, in the viewing interface, the guidance element in association with the interaction control. For example, the electronic device 110 may further display the interaction control 340 in the viewing interface 300 shown in FIG. 3. The guidance element may be displayed according to the location of the interaction control 340, for example, the guidance element may be set within the interaction control 340, thereby avoiding the guidance element from occluding the media content.

In some embodiments, the viewing interface includes a media display area for displaying the media content and the guidance element is outside the media display area. For example, as shown in FIG. 3, the viewing interface 300 may include the media display area including the image content area 320 and the text content area 330. In order to avoid the guidance elements from occluding the media content, it is also possible to display the guidance elements outside the media display area so that the user can achieve quick interface positioning through the guidance elements without interfering with the browsing of the media content.

In some embodiments, since the guidance element may occlude the media content, the electronic device 110 may also set the guidance element in the form of an icon or a button, for example, by pre-setting it to reduce the size of the guidance element so as to occlude as little or no media content as possible. For example, the electronic device 110 may set a plurality of display forms for the guidance element: an icon form, and a content display form. If it is detected that the user selects to display the guidance element in the form of a content display, the electronic device 110 may display the viewing interface 300 as shown in FIG. 3, and the viewing interface 300 includes the guidance element 350, which includes description information associated with the target interaction content of the media content; and if it is detected that the user chooses to display the guidance element in the form of an icon, the electronic device can display a circular icon on the viewing interface, and the user clicks on the circular icon to location the viewing interface to the location of the target interaction content. The present disclosure does not limit the shape content of the icon.

At block 230, the electronic device 110 displays the target interaction content of the media content in response to a predetermined operation for the guidance element.

In some embodiments, the predetermined operation is an operation or task performed automatically by the system when a specific condition or event occurs. For example, the user may trigger the guidance element through any appropriate operation, and the method may be a click operation, a swipe operation, a zoom operation, and so on, which will not be described herein. As an example, the predetermined operation may be a click operation for the guidance element. For example, when the user clicks on the guidance element on the viewing interface, the electronic device 110 receives a corresponding predetermined operation, and then performs interface positioning based on the predetermined operation to display the target interaction content of the media content.

In some embodiments, the electronic device 110 may position the viewing interface to the target interaction content in response to the predetermined operation for the guidance element, and since it is an updated viewing interface obtained by interface positioning against the target interaction content, the updated viewing interface includes the target interaction content. For example, FIG. 5 illustrates a viewing interface 500, that is, the updated viewing interface, and the viewing interface 500 includes the target interaction content. The user may quickly update the viewing interface 300 shown in FIG. 3 to the viewing interface 500 shown in FIG. 5 by clicking the guidance element, so as to quickly position the user to the target interaction content to facilitate the quick understanding of the target interaction content by the user.

In some embodiments, in order to enable the user to understand the specific information of the target interaction content at the first time, the target interaction content may be displayed in a first style in the updated viewing interface, where the first style is different from a second style of a further interaction content in the viewing interface. For example, FIG. 5 is a schematic diagram of highlighting the target interaction content. It is also possible to add a contrasting color to the area where the target interaction content is located, add an animation effect to the area where the target interaction content is located, add a shadow effect to the area where the target interaction content is located, change the outline of the border of the area where the target interaction content is located, change the style of the text of the target interaction content, add an icon mark to the area where the target interaction content is located, add a hover effect to the area where the target interaction content is located, and so on. One or more of these methods can achieve the purpose of highlighting the target interaction content, which will not be repeated here.

In some embodiments, the electronic device 110 may cease displaying of the guidance element on the viewing interface in response to the target interaction content being displayed. For example, after clicking the guidance element in the viewing interface, the user may cease displaying of the guidance element, so that there is no more guidance element in the updated viewing interface, so as to prevent the guidance element from being occluded in the updated viewing interface. In which, the hiding of the guidance element can be realized through exit animation, fade animation and other plurality of ways, which will not be repeated here.

In some embodiments, if the user ignores the guidance element in the viewing interface and directly slides the interface to browse other contents of the viewing interface, the guidance element may be temporarily hidden to avoid affecting the browsing effect of the user. The displaying of the guidance element is ceased in the viewing interface in response to a first sliding operation in a first direction for the viewing interface. For example, the displaying of the guidance element may be ceased when the electronic device 110 detects that the user has slid his or her finger down the screen on the viewing interface. The sliding operation can be implemented in a plurality of ways, for example, the user can utilize a tool such as a finger, a stylus, a mouse, or a keyboard to implement the sliding operation, which will not be described herein.

In some embodiments, the electronic device 110 may adjust, in response to a second sliding operation in a second direction for the viewing interface, a display area of the viewing interface based on the second sliding operation; and redisplay the guidance element in response to the adjusted display area satisfying a predetermined condition. For example, the electronic device 110 may first display the viewing interface of the media content, and then upon detecting that the user applies a finger to perform a downward sliding behavior on the terminal interface, the electronic device 110 may then detect a first sliding operation against the viewing interface, hide the guidance element on the viewing interface, and slide the viewing interface downward to allow the user to browse other contents on the viewing interface. Then, when detecting the user's finger sliding upward on the terminal interface, the electronic device 110 may detect a second sliding operation against the viewing interface, slide the viewing interface upward, and if it detects that the adjusted display area satisfies a predetermined condition, redisplay the guidance element so that the user can still quickly locate the interface according to the guidance element.

In some embodiments, the electronic device 110 redisplays the guidance element in response to the target interaction content not being included in the adjusted display area. For example, when the current terminal displays the viewing interface 500 as shown in FIG. 5, the electronic device 110 may detect a second sliding operation against the viewing interface and slide the viewing interface upward if it detects an upward sliding behavior of the user's finger on the terminal interface. If the viewing interface is slid until the interface does not include the target interaction content, the guidance element may be redisplayed on the viewing interface.

In some embodiments, the predetermined condition may also be set according to an actual situation, for example, the predetermined condition may be set as: if the adjusted display area does not include the interaction content, it indicates that the adjusted display area satisfies the predetermined condition. Alternatively, the predetermined condition may further be set as: if the adjusted display area does not include the target interaction content, it indicates that the adjusted display area satisfies the predetermined condition. Alternatively, the predetermined condition may further be set as: the location of the adjusted display area is the same as the initial location of the viewing interface, it indicates that the adjusted display area satisfies the predetermined condition, and so on. In some embodiments, the electronic device 110 may also redisplay the guidance element upon detecting that the updated viewing interface is slid to the same position as the initial viewing interface. For example, if the viewing interface 500 shown in FIG. 5 is currently displayed on the terminal, and if a user's finger is detected to perform an upward sliding behavior on the terminal interface, the electronic device 110 may detect a second sliding operation against the viewing interface and slide the viewing interface upward. If this viewing interface is slid upward to the viewing interface 300 as shown in FIG. 3, it means that the viewing interface has been slid to the same position as the initial viewing interface, and at this time the guidance element can be redisplayed on the viewing interface.

In some embodiments, since more than one image may be included in the viewing interface, when the user sees the viewing interface, he or she may be attracted by the image, and then the specific content of the image is viewed by sliding the image from side to side, at which time the displaying of the guidance element may be maintained in the viewing interface, so that the user may apply the guidance element at any time to perform an interface positioning operation. Accordingly, the electronic device 110 may display a first image of the plurality of images in the viewing interface; and switch, in response to a received image switching operation, to display a second image of the plurality of images in the viewing interface, and maintaining the displaying of the guidance element.

For example, the electronic device 110 may display the first display mode of the viewing interface of FIG. 3, and after the user sees the viewing interface 300, he or she founds that the image content area 320 in the viewing interface 300 includes more than one image, so that the finger may slide left and right in the terminal interface to switch the image displayed in the image content area 320. The displaying of the guidance element 350 is maintained throughout the image switching process. With this manner the user can then apply the guidance element to quickly perform the interface positioning operation after viewing the picture.

In some embodiments, since the viewing interface may also include a video, the user, upon seeing the viewing interface, may be attracted to the video and then view the specific content of the video by clicking on it, at which time the displaying of the guidance element may be maintained in the viewing interface so that the user may readily apply the guidance element to perform the interface positioning operation. For example, the electronic device 110 may display the first display mode of the viewing interface of FIG. 3. After seeing the viewing interface 300 and realizing that the image content area 320 in the viewing interface 300 includes a video, the user may click with his or her finger on the terminal interface to play the video in the image content area 320. Throughout the process of the video playing, the displaying of the guidance element 350 is always maintained. In this way, the user will be able to apply the guidance element to quickly perform the interface positioning operation even after viewing the video.

In some embodiments, a mechanism for filtering the target interaction content from the interaction content may also be pre-programmed to ensure the importance of the target interaction content. The electronic device 110 may determine an interaction content collection associated with the media content; and determine the target interaction content from the interaction content collection based on interaction information of at least one interaction content in the interaction content collection. This mechanism for filtering the target interaction content may be adapted according to the actual situation and is not described herein.

For example, the predetermined threshold can be pre-set to 50, if the number of detected interaction content exceeds 50, that is, the number of interaction content reaches the predetermined threshold at this time. It indicates that the media content has obtained many interactions, and the user will consume many time costs to browse through all of these interaction contents, so in order to enhance the efficiency of the user's use, it is possible to filter out the most important target interaction content from these interaction contents, so that the user can quickly position himself or herself to the target interaction content through the guidance element, which greatly enhances the user's experience of using the media content. In which the predetermined threshold may be adjusted according to the actual situation, and will not be discussed herein. For a further example, the predetermined threshold may be predetermined as 50, and if it is detected that the number of items of the interaction content does not exceed 50, indicating that the media content has obtained fewer interactions, then there is no need to filter the target interaction content from the interaction content.

In some embodiments, the target interaction content with the highest number of interactions may also be filtered from the interaction content based on the number of interactions corresponding to each interaction content. In which the number of interactions is the number of interaction operations performed by the user with respect to the interaction content, such as the number of interactions may be the number of likes, the number of reposts, the number of comment backs, and so on, which will not be discussed herein. For example, the interaction content with the highest number of likes may be determined as the target interaction content, and so on.

In some embodiments, in order to ensure that the user may see the target interaction content first, the target interaction content may also be placed at a first place in the display area of the interaction content in the viewing interface, so as to ensure that the user will be the first to see the target interaction content among the interaction contents when sliding down the interface with a finger. Also, the user will still see the target interaction content at the first place of the interaction content display area in the viewing interface after applying the guidance element for interface positioning.

Based on this manner, the present disclosure is embodiments in which the user can click on a guidance element in the viewing interface to quickly position the viewing interface to a location of a target interaction content. Moreover, the user can also understand the function of the guidance element through the description information associated with the target interaction content on the guidance element, thereby helping the user to better obtain information about the target interaction content.

### Example Apparatus and Device

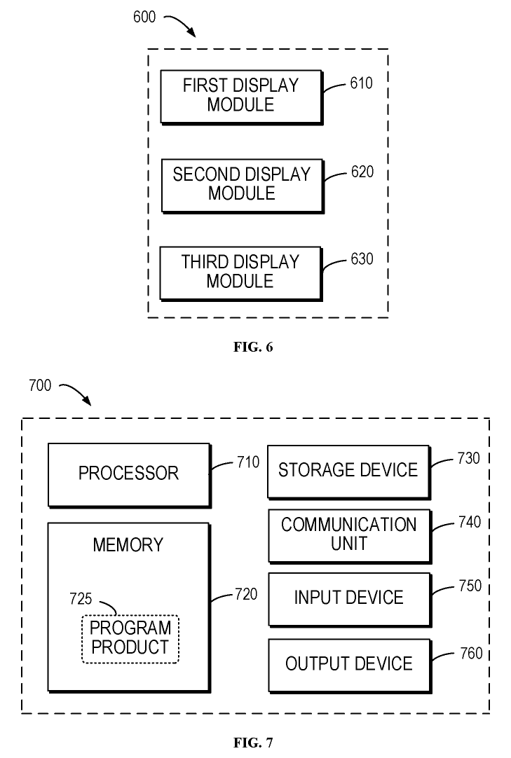

The embodiments of the present disclosure also provide a corresponding apparatus for implementing the above method or process. FIG. 6 illustrates a schematic structural block diagram of an apparatus 600 for interface interaction according to some embodiments of the present disclosure. The apparatus 600 may be implemented or included in the electronic device 110 as discussed above. The various modules/components in the apparatus 600 may be implemented by hardware, software, firmware, or any combination thereof.

As shown in FIG. 6, the apparatus 600 includes: a first display module 610 configured to display a viewing interface of a media content; a second display module 620 configured to display a guidance element in the viewing interface, the guidance element including description information associated with a target interaction content of the media content; and a third display module 630 configured to display the target interaction content of the media content in response to a predetermined operation for the guidance element.

In some embodiments, the guidance element includes at least one of: at least part of the target interaction content; identification information of a poster of the target interaction content; or interaction information associated with the target interaction content.

In some embodiments, the guidance element is associated with a maximum display size, where the at least part of the target interaction content is determined based on the maximum display size.

In some embodiments, the second display module 630 is further configured to display the target interaction content of the media content in response to a predetermined operation for the guidance element, and display the target interaction content in a first style in the updated viewing interface, where the first style is different from a second style of a further interaction content in the viewing interface.

In some embodiments, the second display module 620 is further configured to display the target interaction content of the media content in response to a predetermined operation for the guidance element, and cease displaying of the guidance element on the viewing interface in response to the target interaction content being displayed.

In some embodiments, the interface interaction apparatus is further configured to display a viewing interface of a media content, and cease the displaying of the guidance element in the viewing interface in response to a first sliding operation in a first direction for the viewing interface.

In some embodiments, the interface interaction apparatus is further configured to display a viewing interface of the media content, cease the displaying of the guidance element in the viewing interface in response to a first sliding operation in a first direction for the viewing interface, and adjust , in response to a second sliding operation in a second direction for the viewing interface, a display area of the viewing interface based on the second sliding operation; and redisplay the guidance element in response to the adjusted display area satisfying a predetermined condition.

In some embodiments, the interface interaction apparatus is further configured to display a viewing interface of the media content, cease the displaying of the guidance element in the viewing interface in response to a first sliding operation in a first direction for the viewing interface, and adjust , in response to a second sliding operation in a second direction for the viewing interface, a display area of the viewing interface based on the second sliding operation; and redisplay the guidance element in response to the target interaction content not being included in the adjusted display area.

In some embodiments, the third display module 630 is further configured to display a first image of the plurality of images in the viewing interface; and switch, in response to a received image switching operation, to display a second image of the plurality of images in the viewing interface, and maintaining the displaying of the guidance element.

In some embodiments, the second display module 620 is further configured to display, in the viewing interface, the guidance element in association with the interaction control.

In some embodiments, the viewing interface includes a media display area for displaying the media content and the guidance element is outside the media display area.

In some embodiments, the target interaction content is determined based on the following: determining an interaction content collection associated with the media content; and determining the target interaction content from the interaction content collection based on interaction information of at least one interaction content in the interaction content collection.

In some embodiments, the target interaction content includes a comment content for the media content.

The units included in the apparatus 600 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the units in the apparatus 600 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

FIG. 5 illustrates a block diagram of an electronic device 500 in which one or more embodiments of the present disclosure may be implemented. It would be appreciated that the electronic device 500 illustrated in FIG. 5 is merely example and would not constitute any limitation on the functionality and scope of the embodiments described herein. The electronic device 500 shown in FIG. 5 may be configured to implement the electronic device 110 shown in FIG. 1.

As shown in FIG. 7, the electronic device 700 is in the form of a general-purpose electronic device. Components of the electronic device 700 may include, but are not limited to, one or more processors or processing units 710, a memory 720, a storage device 730, one or more communication units 740, one or more input devices 750, and one or more output devices 760. The processor 710 may be an actual or virtual processor and capable of performing various processes according to programs stored in the memory 720. In multiprocessor systems, multiple processors execute computer-executable instructions in parallel to improve parallel processing capabilities of electronic device 700.

The electronic device 700 typically includes a plurality of computer storage media. Such media may be any available media accessible to the electronic device 700, including, but not limited to, volatile and non-volatile media, removable and non-removable media. The memory 720 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 730 may be a removable or non-removable medium and may include a machine-readable medium, such as a flash drive, magnetic disk, or any other medium, which may be capable of storing information and/or data (e.g., training data for training) and may be accessed within the electronic device 700.

The electronic device 700 may further include additional removable/non-removable, volatile/non-volatile storage media. Although not illustrated in FIG. 7, a disk drive for reading from or writing to a removable, non-volatile disk (e.g., a ‘floppy disk’) and an optical disk drive for reading from or writing to a removable, non-volatile optical disk may be provided. In these embodiments, each drive may be connected to a bus (not illustrated) by one or more data media interfaces. The memory 720 may include a computer program product 727 having one or more program modules that are configured to perform various methods or actions of various embodiments of the present disclosure.

The communication unit 740 implements communication with other electronic devices via a communication medium. Additionally, the functions of the components of the electronic device 700 may be implemented as a single computing cluster or a plurality of computing machines that are capable of communicating over a communication connection. Thus, the electronic device 700 may use logical connections to one or more other servers, networked personal computers (PCs), or a further network node to operate in a networked environment.

The input device 750 may be one or more input devices, such as a mouse, a keyboard, a tracking ball, and the like. The output device 760 may be one or more output devices, such as a monitor, a speaker, a printer, and the like. The electronic device 700 may also communicate, as desired, via the communication unit 740, with one or more external devices (not illustrated), external devices such as storage devices, display devices, etc., with one or more devices that enable a user to interact with the electronic device 700, or with any device that enables the electronic device 700 to communicate with one or more other electronic devices (e.g., a network card, modem, etc.) to communicate. Such communication may be performed via an input/output (I/O) interface (not illustrated).

According to an example implementation of the present disclosure, there is provided a computer-readable storage medium having computer-executable instructions stored thereon, where the computer-executable instructions are performed by a processor to implement the method described above. According to an example implementation of the present disclosure, there is also provided a computer program product, the computer program product being tangibly stored on a non-transient computer-readable medium and including computer-executable instructions, where the computer-executable instructions are performed by a processor to implement the methods described above.

Aspects of the present disclosure are described herein with reference to flowcharts and/or block diagrams of methods, apparatuses, devices, and computer program products implemented according to the present disclosure. It would be appreciated that each block of the flowchart and/or block diagram, and combinations of blocks in the flowcharts and/or block diagrams, may be implemented by computer readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce means to implement the functions/acts specified in the flowchart and/or block diagram. These computer-readable program instructions may also be stored in a computer-readable storage medium that causes the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, function, and operation of possible implementations of systems, methods, and computer program products according to various implementations of the present disclosure. In this regard, each block in the flowchart or block diagram may represent a module, program segment, or part of an instruction that includes one or more executable instructions for implementing the specified logical function. In some alternative implementations, the functions noted in the blocks may also occur in a different sequence than noted in the figures. For example, two consecutive blocks may actually be performed substantially in parallel, which may sometimes be performed in the reverse sequence, depending on the function involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations would be apparent to those of ordinary skill in the art without departing from the scope and spirit of the various implementations illustrated. The determination of the terms used herein is intended to best explain the principles of the implementations, practical applications, or improvements to techniques in the marketplace, or to enable others of ordinary skill in the art to understand the various implementations disclosed herein.

What is claimed is:

1. A method for interface interaction, comprising:
displaying a viewing interface of a media content;
displaying a guidance element in the viewing interface, the guidance element comprising description information associated with a target interaction content of the media content; and
updating the viewing interface in response to a predetermined operation for the guidance element to display the target interaction content of the media content.

2. The method of claim 1, wherein the guidance element comprises at least one of:
at least part of the target interaction content;
identification information of a poster of the target interaction content; or
interaction information associated with the target interaction content.

3. The method of claim 2, wherein the guidance element is associated with a maximum display size, wherein the at least part of the target interaction content is determined based on the maximum display size.

4. The method of claim 1, further comprising:
displaying the target interaction content in a first style in the updated viewing interface, wherein the first style is different from a second style of a further interaction content in the viewing interface.

5. The method of claim 1, wherein updating the viewing interface comprises:
ceasing the displaying of the guidance element on the viewing interface in response to the target interaction content being displayed.

6. The method of claim 1, wherein before receiving the predetermined operation for the guidance element, the method further comprises:
ceasing the displaying of the guidance element in the viewing interface in response to a first sliding operation in a first direction for the viewing interface.

7. The method of claim 6, wherein after ceasing the displaying of the guidance element in the viewing interface, the method further comprises:
adjusting, in response to a second sliding operation in a second direction for the viewing interface, a display area of the viewing interface based on the second sliding operation; and
redisplaying the guidance element in response to the adjusted display area satisfying a predetermined condition.

8. The method of claim 7, wherein redisplaying the guidance element in response to the adjusted display area satisfying the predetermined condition comprises:
redisplaying the guidance element in response to the target interaction content not being comprised in the adjusted display area.

9. The method of claim 1, wherein the media content is associated with a plurality of images, and before displaying the target interaction content of the media content, the method further comprises:
displaying a first image of the plurality of images in the viewing interface; and
switching, in response to a received image switching operation, to display a second image of the plurality of images in the viewing interface, and maintaining the displaying of the guidance element.

10. The method of claim 1, wherein the viewing interface comprises an interaction control for receiving an interaction content associated with the media content, and displaying the guidance element in the viewing interface comprises:
displaying, in the viewing interface, the guidance element in association with the interaction control.

11. The method of claim 1, wherein the viewing interface comprises a media display area for displaying the media content and the guidance element is outside the media display area.

12. The method of claim 1, wherein the target interaction content is determined based on the following:
determining an interaction content collection associated with the media content; and
determining the target interaction content from the interaction content collection based on interaction information of at least one interaction content in the interaction content collection.

13. The method of claim 1, wherein the target interaction content comprises a comment content for the media content.

14. An electronic device, comprising:
at least one processor; and
at least one memory coupled to the at least one processor and storing instructions for execution by the at least one processor, the instructions, when executed by the at least one processor, causing the electronic device to perform operations comprising:
displaying a viewing interface of a media content;
displaying a guidance element in the viewing interface, the guidance element comprising description information associated with a target interaction content of the media content; and
updating the viewing interface in response to a predetermined operation for the guidance element to display the target interaction content of the media content.

15. The electronic device of claim 14, wherein the guidance element comprises at least one of:
at least part of the target interaction content;
identification information of a poster of the target interaction content; or
interaction information associated with the target interaction content.

16. The electronic device of claim 15, wherein the guidance element is associated with a maximum display size, wherein the at least part of the target interaction content is determined based on the maximum display size.

17. The electronic device of claim 14, wherein the operations further comprise:
displaying the target interaction content in a first style in the updated viewing interface, wherein the first style is different from a second style of a further interaction content in the viewing interface.

18. The electronic device of claim 14, wherein updating the viewing interface comprises:
ceasing the displaying of the guidance element on the viewing interface in response to the target interaction content being displayed.

19. The electronic device of claim 14, wherein before receiving the predetermined operation for the guidance element, the operations further comprise:
ceasing the displaying of the guidance element in the viewing interface in response to a first sliding operation in a first direction for the viewing interface.

20. A non-transitory computer-readable storage medium having computer-executable instructions stored thereon, the computer-executable instructions, when executed by a processor, performing operations comprising:
displaying a viewing interface of a media content;
displaying a guidance element in the viewing interface, the guidance element comprising description information associated with a target interaction content of the media content; and
updating the viewing interface in response to a predetermined operation for the guidance element to display the target interaction content of the media content.
